(19) United States
(12) Patent Application Publication
(10) Pub. No.: US 2004/0081946 A1
(43) Pub. Date: Apr. 29, 2004

(54) Trust fall mat

(76) Inventor: Lain Hensley, Chico, CA (US)

Correspondence Address: DANIEL P. MAGUIRE, 423 E ST., DAVIS, CA, 95616, US

(21) Appl. No.: 10/269,331

(22) Filed: Oct. 11, 2002

(51) Int. Cl. G09B 9/00

(52) U.S. Cl. 434/247

(57) ABSTRACT

A “trust fall” mat having peripheral handles, a catching mat, and optional lateral supports is disclosed. The mat can be used to catch individuals falling during trust fall or other team-building exercises.

### BACKGROUND OF THE INVENTION

1. Field of the Invention

This invention relates to devices for use with trust falls and other team-building activities.

2. General Background

“Trust falls” are a common team-building exercise used by corporations and other groups to foster trust among groups of people. In a trust fall, an individual lets himself or herself fall backwards from a standing position. A number of other individuals stand behind the “faller,” ready to catch the person before he or she hits the ground. The point of the exercise is for the faller to learn that he or she can count on the others for back-up and support.

However, trust falls can be dangerous, both because the catchers might lose their grip and drop the faller, and because the faller might swing his or her arms out when falling and hit the catchers. Also, because it involves hand-to-body contact between a number of people, conventional trust falls can be embarrassing or uncomfortable for some.

Therefore, there is a need to improve the safety of trust falls, and to provide a means so that participants do not have to catch the faller with their bare hands.

### SUMMARY OF THE INVENTION

The present invention is a “trust fall mat,” which can be held by participants to catch the faller in trust fall exercise. The mat is large enough to catch most any person, and has handles at the periphery for the catchers to hold. The mat can be made of cloth, webbing, canvas, plastic, re-inforced fabric, etc. It can also have lateral supports for increased strength.

### BRIEF DESCRIPTION OF THE DRAWINGS

FIG. 1 is a frontal perspective view of a trust fall mat according to the present invention, with participants using the mat.

FIG. 2 is a side cut-away perspective view, taken along line 2-2 of FIG. 1, of a trust fall mat according to the present invention.

FIG. 3 is a top view of a trust fall mat according to the present invention.

FIG. 4 is a bottom view of a trust fall mat according to the present invention.

FIG. 5 is a side view of a trust fall mat according to the present invention.

FIG. 6 is a close-up of a portion of a trust fall mat according to the present invention, as identified in FIG. 4.

FIG. 7 is a side cross-sectional view of the portion of a trust fall depicted in FIG. 6, taken along line 7-7.

### DETAILED DESCRIPTION

The present invention is a trust fall mat 10 comprised of handles 20, a catching mat 30, and optional lateral supports 40.

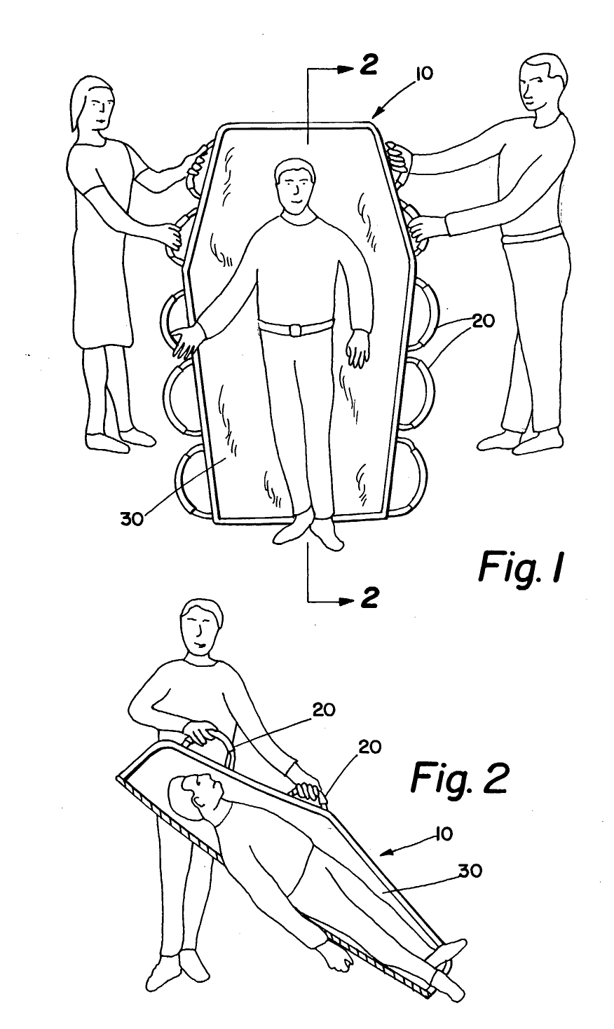

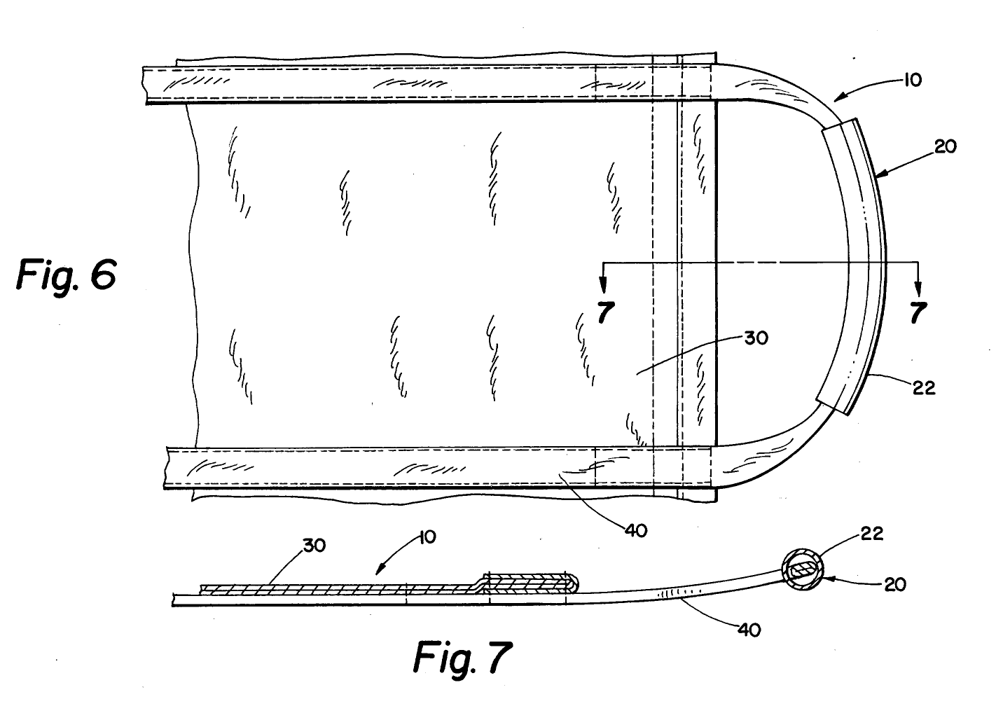

As shown in FIGS. 1-7, the handles 20 are placed around the periphery of the mat, and are used by participants to hold the mat while another participant falls into the mat. The handles may have cylindrical grips 22 for ease of holding, as depicted in FIGS. 6&7. The trust fall mat may also have a top handle 24, placed at the portion of the mat near where the faller's head will land. The handles can be made of many materials, including cloth, canvas, plastic, fabric, rubber, wood, etc.

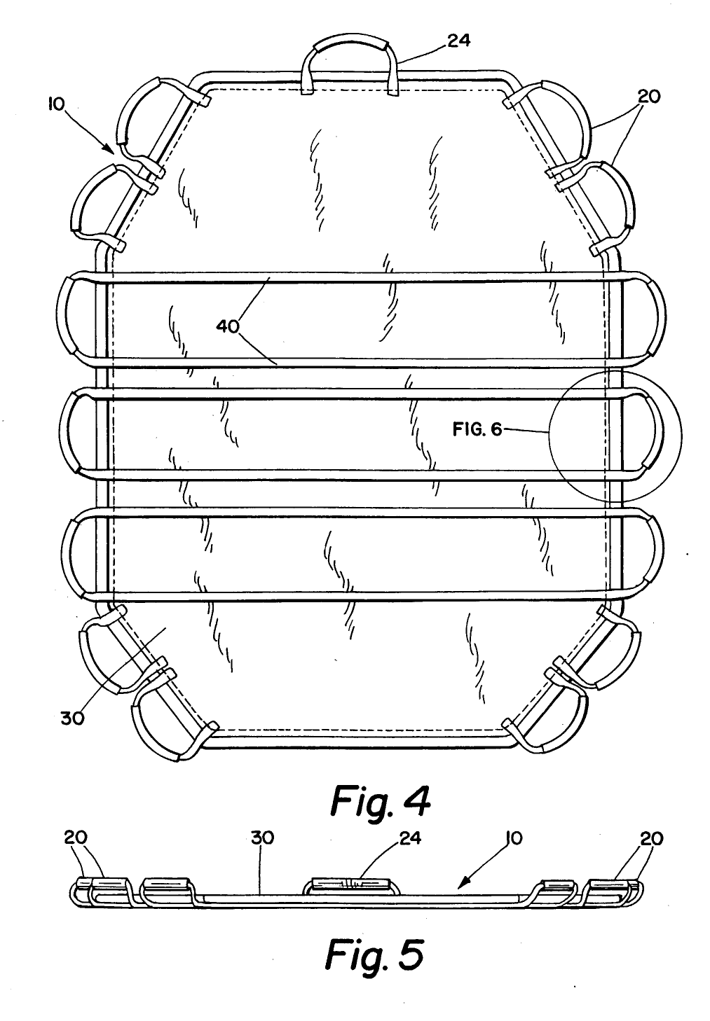

The handles can be attached to the catching mat through conventional means, including adhesives, stitches, mechanical fasteners, etc. See FIG. 4. In one embodiment of the present invention, some of the handles 20 extend into lateral supports 40. These supports 50 provide extra strength.

The catching mat 30 can be large enough to accommodate even large persons, and can be made of strong material, such as cloth, canvas, plastic, fabric, etc. In one embodiment, the area of the mat may be large enough to catch a human being, but not so large as to make it cumbersome for as few as two individuals to use the mat as catchers. In this embodiment, the area of the mat could be from 15 to 70 square feet. In one particular version of this invention, the mat is approximately six feet wide by seven feet long, thus providing an area of 42 square feet.

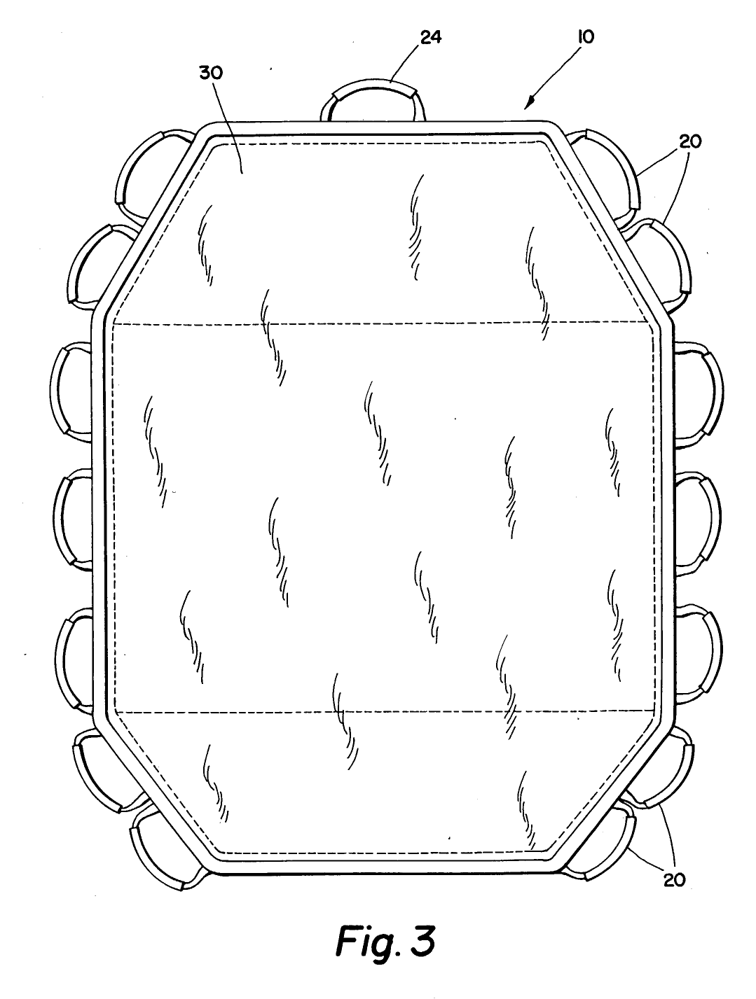

The mat 30 can take any number of shapes, including the six-sided shape shown in FIGS. 3&4, as well more circular shapes, or a simple rectangular or square shape. Other shapes include but are not limited to: substantially triangular, five-sided, oval, key-shaped, etc.

In operation, a plurality of participants hold the mat 10 using the handles 20. See FIG. 1. The “faller” would stand in front of the mat, typically facing away from the other participants, and would let himself or herself fall backwards into the mat. The trust fall would thus be completed, with improved safety due to the superior catching ability of the mat.

One skilled in the art will appreciate that the present invention can be practiced by other than the preferred embodiments, which are presented for purposes of illustration and not of limitation.

I claim:

1.) A method for a plurality of individuals to catch a participant in a team-building exercise, comprising:
providing a mat having handles around its periphery;
having said individuals hold said mat;
placing said mat near to said participant; and
catching said participant using said mat as said participant falls.

2). The method according to claim 1, wherein the number of said individuals exceeds two.

3). The method according to claim 1, wherein said mat has lateral supports.

4). The method according to claim 3, wherein said lateral supports are integral with said handles.

5.) The method according to claim 4, wherein at least one of said handles has a grip.

6). The method according to claim 5, wherein said mat additionally comprises a top handle.

7). A mat for catching individuals falling from a standing position, comprising:
a mat, said mat having a peripheral area; and
a plurality of handles attached to said peripheral area.

8.) The mat according to claim 7, wherein said mat has an area, and said area is between 15 and 70 square feet.

9.) The mat according to claim 8, additionally comprising lateral supports within said mat.

10). The mat according to claim 9, wherein said lateral supports are integral with said handles.

11). The mat according to claim 10, wherein at least one of said handles has a grip.

12). The mat according to claim 11, additionally comprising a top handle.

13.) A trust fall mat, comprising:
a six-sided mat, said mat sized so as to fit a single human being, said mat having a peripheral area;
a plurality of handles attached to said peripheral area.

14.) The mat according to claim 13, wherein said mat has lateral supports.

15). The mat according to claim 14, wherein said lateral supports are integral with said handles.

16). The mat according to claim 15, wherein at least one of said handles has a grip.

17). The mat according to claim 16, additionally comprising a top handle.
